(19) United States
(12) Patent Application Publication
(10) Pub. No.: US 2026/0057201 A1
(43) Pub. Date: Feb. 26, 2026

(54) Bioptic Reader Assembly with Video Processing Module

(71) Applicant: ZEBRA TECHNOLOGIES CORPORATION, Lincolnshire, IL (US)

(72) Inventors: Darran Michael Handshaw, Sound Beach, NY (US); Edward Barkan, Miller Place, NY (US); Mark Drzymala, Saint James, NY (US)

(21) Appl. No.: 18/810,221

(22) Filed: Aug. 20, 2024

(51) Int. Cl. G06K 7/10; G06V 10/12; G06V 10/94

(52) U.S. Cl. CPC G06K 7/1096; G06V 10/12; G06V 10/955

(57) ABSTRACT

A bioptic indicia reader assembly includes a housing with a bottom portion and a top portion, each containing respective windows. A platter with an optically transmissive window aligns with the bottom-portion window. The assembly features a decoder module for decoding indicia from image data and a separate video processing module (VPM) for processing video streams. The VPM is strategically positioned within the top portion of the housing. The assembly includes a first imaging assembly capturing image data for the decoder module and a second imaging assembly capturing image data for the VPM, each extending through the respective windows. The top portion of the housing may include separate compartments for optical components and the VPM, with environmental sealing and heat dissipation features. The VPM is configured for various machine vision tasks, enhancing the functionality of the bioptic indicia reader in retail and other applications.

### FIELD OF THE DISCLOSURE

At least some embodiments of the present disclosure relate generally to barcode reader assemblies and, in particular, to barcode readers having video processing modules positioned within the upper portion of the housing.

### BACKGROUND

Bioptic reader assemblies for use at a point-of-sale typically include a scale assembly for use in weighing products and a barcode reader, such as a bioptic barcode reader, installed with the scale assembly for reading and decoding barcodes displayed on products. In addition to being able to scan product barcodes and weigh products, it could also be beneficial in certain applications for the bioptic reader assembly to have a machine vision capable camera that can be used for object recognition, anti-shrink applications, etc.

However, to use a camera for object recognition, anti-shrink applications, etc., a processing module is required. Typical bioptic reader assemblies may not have the space within the lower portion of the housing for the required processing module and routing of the required cables. Therefore, integrating the video processing module within the upper portion of the housing can provide a compact and efficient solution.

### SUMMARY

In an embodiment, the present disclosure relates to a bioptic indicia reader assembly comprising a housing having a bottom portion and a top portion extending above the bottom portion, the bottom portion including a bottom-portion window and the top portion including a top-portion window. A platter is positioned adjacent the top section of the bottom portion of the housing, the platter having an optically transmissive window that aligns with the bottom-portion window of the bottom portion of the housing. A decoder module is positioned within the housing and configured to decode indicia provided to the decoder module in image data. A video processing module that is separate from the decoder module is configured to process a stream of image data representing a video stream, the video processing module being positioned at least partially within the top portion of the housing. A first imaging assembly is configured to capture first image data over a first field of view (FOV) extending through at least one of the bottom-portion window and the top-portion window, the first image data being transmitted to the decoder module. A second imaging assembly is configured to capture second image data over a second FOV extending through at least one of the bottom-portion window and the top-portion window, the second image data being transmitted to the video processing module.

In another embodiment, the present disclosure relates to a video processing module for integration into a bioptic indicia reader, the bioptic indicia reader comprising a housing having a bottom portion and a top portion extending above the bottom portion, the video processing module comprising: a processing unit configured to process a stream of image data representing a video stream; a printed circuit board on which the processing unit is mounted, the printed circuit board configured to be positioned at least partially within the top portion of the housing of the bioptic indicia reader; a first imaging assembly configured to capture first image data over a FOV extending through at least one of a bottom-portion window of the bottom portion and a top-portion window of the top portion of the housing, the first image data being transmitted to a decoder module of the bioptic indicia reader; and a second imaging assembly configured to capture second image data over a second FOV extending through at least one of the bottom-portion window and the top-portion window, the second image data being transmitted to the video processing module.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed examples, and explain various principles and advantages of those embodiments.

FIG. 1 illustrates a perspective view of an example bioptic reader installed at a workstation;

FIG. 2 illustrates a block diagram of an example bioptic reader;

FIG. 3 illustrates a rear-perspective view of an example bioptic reader with a rear cover removed;

FIGS. 4 and 5 illustrate cross-section views of an example bioptic reader in accordance with embodiments of the present disclosure.

Skilled artisans will appreciate that elements in the figures are illustrated for simplicity and clarity, and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

The examples disclosed herein relate to bioptic reader assemblies that include video processing modules that can be used to receive images from a camera of a bioptic barcode reader and process and interpret the images, for example through one or more of object recognition, video monitoring for retail loss prevention, convolutional neural network capabilities, gesture recognition, video feed capabilities, optical character recognition, and other vision processes that rely on a series of images forming a video stream. In the examples shown, the video processing modules are positioned within the upper portion of the housing of the bioptic barcode reader.

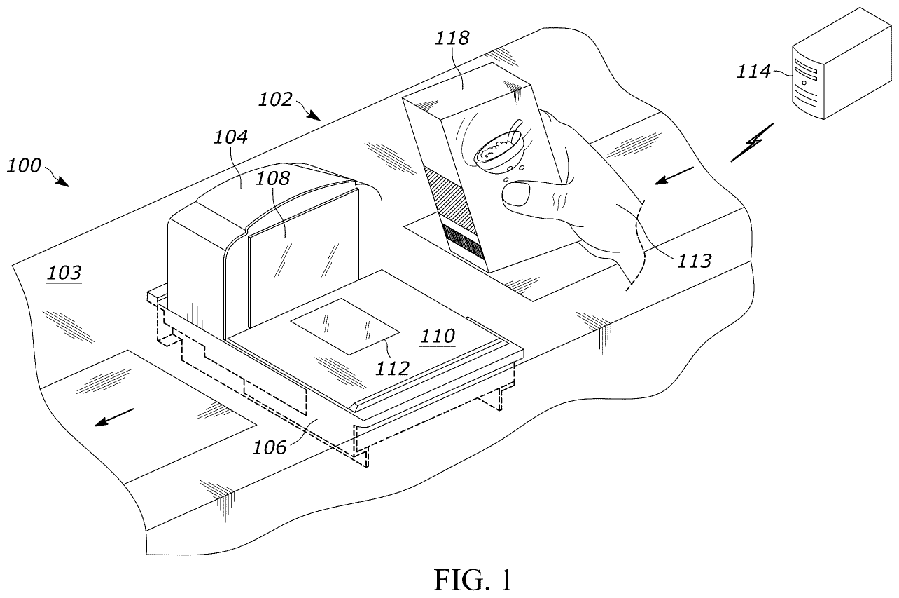

Referring to FIG. 1, it illustrates a perspective view of an example bioptic indicia reader 100 for housing a video processing module in accordance with various embodiments of the present disclosure. As used herein, the term indicia should be understood to refer to any kind of visual marker that can be associated with an item. For example, indicia can be a 1D, 2D, or 3D barcode, a graphic, a logo, etc. Additionally, indicia may comprise encoded payload data as, for example, is the case with a 1D or 2D barcode where the barcode encodes a payload comprised of, for example, alphanumeric or special characters that may be formed into a string. In the illustrated example, the bioptic indicia reader 100 is shown as part of a point-of-sale (POS) system arrangement 102 having the bioptic indicia reader 100 positioned within a workstation counter 103. Generally, the indicia reader 100 includes an upper housing 104 (also referred to as an upper portion, upper housing portion, or tower portion) and a lower housing 106 (also referred to as a lower portion, lower housing portion, or platter portion). The upper housing 104 can be characterized by an optically transmissive window 108 positioned therein along a generally vertical plane and a horizontally extending field of view(s) which passes through the window 108. The lower housing 106 can be characterized by a platter 110 that includes an optically transmissive window 112 positioned therein along a generally horizontal plane and a vertically extending field of view(s) which passes through the window 112. The platter 110 may be a weigh platter and can be a part of a weigh platter assembly that generally includes the weigh platter 110 and a scale (or load cell) configured to measure the weight of an object placed the top surface of the weight platter 110. To avoid weight disturbances, the weigh platter is generally configured to rest wholly on the load cell (or portions thereof designed to support the weigh platter) such that the entire weight of the weigh platter along with any object placed therein is fully transferred to the load cell.

In operation, the indicia reader 100 can be used in multiple modes, including a mode where item-related data is passed to a point-of-sale (POS) host device based on the weight of an item involved in a transaction and a mode where item-related data is passed to a POS host device without regard for the weight of an item involved in a transaction.

In the latter mode, a user 113 generally passes an item 114 across a product scanning region of the indicia reader 100 in a swiping motion in some general direction, which in the illustrated example is right-to-left. A product scanning region can be generally viewed as a region that extends above the platter 110 and/or in front of the window 108 where indicia reader 100 is operable to capture image data of sufficient quality to perform imaging-based operations like decoding indicia that appears in the obtained image data. It should be appreciated that while items may be swiped past the indicia reader 100 in either direction, items may also be presented into the product scanning region by means other than swiping past the window(s). When the item 114 comes into the any of the fields of view of the reader, the indicia 116 on the item 114 is captured and decoded by the indicia reader 100, and corresponding data is transmitted to a communicatively coupled host 118 (commonly comprised of a point of sale (POS) terminal). Further to capturing data for decode purposes, the indicia reader may have one or more imaging assemblies configured for capturing streams of image data used for vision purposes. These can include, but are not limited to object identification, user observation, shrink detection, and other vision operations which do not directly rely on the decoding of an indicia.

Indicia reader 100 can utilize a variety of imaging assemblies and optical components to achieve the desired field of view(s) FOV(s) over which image data can be captured and transmitted to a processing host (such as a decoder, processor (like a video processor), or ASIC that may be internal to the indicia reader 100). For example, an imaging assembly may include an image sensor (also referred to as an imager or imaging sensor) that can be, for example, a CCD or a CMOS imaging sensor and may either be a linear or a two-dimensional sensor. Linear image sensors generally include multiple photosensitive pixel elements aligned in a one-dimensional array. Two-dimensional sensors generally include mutually orthogonal rows and columns of photosensitive pixel elements arranged to form a substantially flat square or rectangular surface. Such imagers are operative to detect light captured by an imaging lens assembly along a respective optical path or axis that normally traverses through either of the generally horizontal or generally upright window(s). In instances where multiple imaging assemblies are used, each respective imager and imaging lens assembly pair is designed to operate together for capturing light scattered, reflected, or emitted from indicia as pixel data over a respective FOV. In other instances, a single imaging assembly may be used to generate a single primary FOV which may be split, divided, and/or folded to generate multiple FOVs. In such cases, data collected from various portions of the imaging sensor may be evaluated as if it was obtained by an individual imaging assembly/imaging sensor. Additionally, different imaging assemblies may be communicatively coupled to different processing components for appropriate data processing.

As noted previously, in some instances indicia readers like the reader 100 may include a video processing unit specifically for processing video stream data, and particularly data which is not provided primarily for indicia decoding purposes. Normally, indicia decoding does not require image data of relatively high fidelity. Instead, this data can be of relatively low quality, being presented in monochrome and captured over fields of view that are specifically configured for likely presence of said indicia during checkout procedures. These images are typically not suitable non-decoding, vision processing due to their relatively low quality and limited field of view orientation. For example, while capturing images of items positioned near the image reader 100 may be undesirable for indicia decode purposes as such images may lead to unintended decode events, having vision monitoring extending over those regions may be desirable as it may provide data that may be beneficial to the operation of the reader. However, processing vision data and conducting decode operations typically require different hardware and for that reason processor(s) which may be connected to the vision imaging assemblies (assemblies which capture image data for vision processing) may be positioned in different locations and/or on separate circuit boards from decoding imaging assemblies (assemblies which capture image data for decoding purposes).

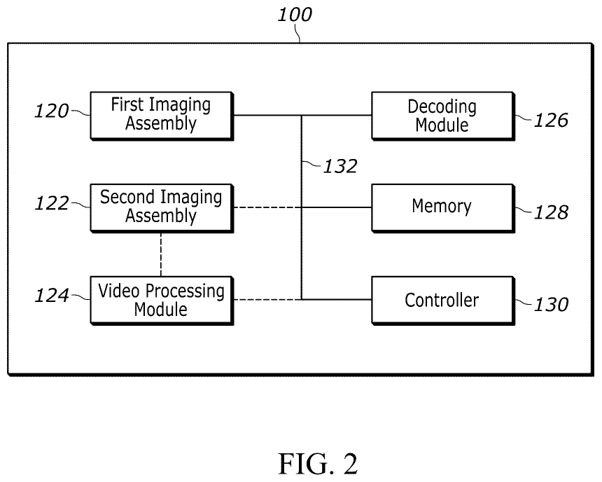

Referring now to FIG. 2, shown therein is a block diagram representing an example indicia reader 100 of the present disclosure. Reader 100 generally includes a first imaging assembly 120 and a second imaging assembly 122. In some embodiments, the first imaging assembly 120 is optimized for capturing image data for indicia decoding purposes and the second imaging assembly 122 is optimized for capturing image data for vision processing purposes that go beyond indicia decoding. Additionally, the reader 100 includes a video processing module 124 configured to receive image data from the imaging assembly that is optimized for capturing image data for vision processing purposes (e.g., second imaging assembly 122) and conduct machine vision processing operations thereon. The video processing module 124 is embodied in a hardware device that can include its own processing and control circuitry along with memory and relevant instructions for performing the necessary operations. The reader 100 also includes a decoding module 126 (also referred to as a decoder or a decoder module) configured to accept image data from the imaging assembly optimized for capturing barcode data (e.g., first imaging assembly 120) and process said data to extract one or more payloads associated with various indicia present in said image data. The decoding module may be embodied in a hardware configuration, or it may be a logical module that is a part of some relatively general-purpose processor. Additionally, the reader 100 includes a memory 128 and a controller 130 whereby the memory stores machine readable instructions which, when executed by the controller (also referred to as a processor) cause the reader 100 to operate as intended. The various modules and assemblies of reader 100 are communicatively coupled via the bus 132 which is illustrated logically and not literally. It should be appreciated the second imaging assembly and the video processing module can be coupled in any number of ways where information from the second imaging assembly may be received by the video processing module. For example, the video processing module 124 may be connected to the second imaging assembly 124 and the bus 132, whereby control signal information mat be transmitted to the second imaging assembly 122 via the video processing module 124. In other instances the link to the bus 132 may be established via the second imaging assembly 122. Additionally, image data may be passed from the image assembly to the video processing module via the but 132, omitting the connection between the imaging assembly and the video processing module.

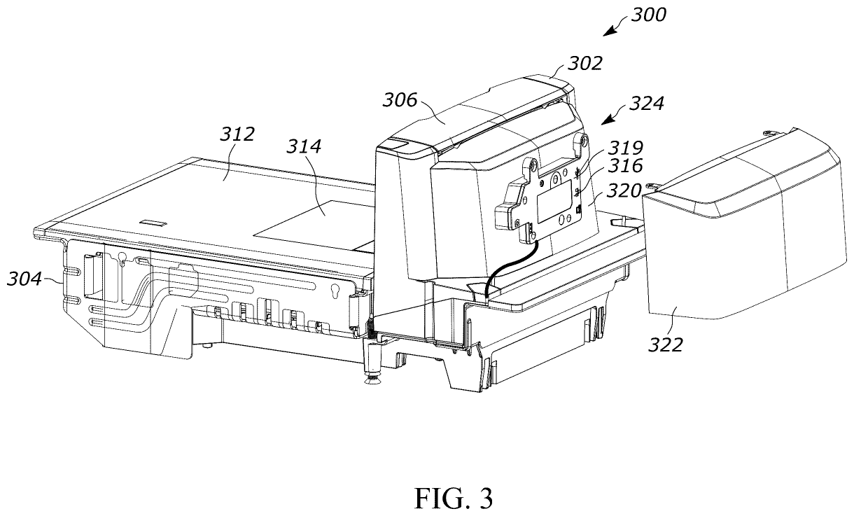

Moving now to FIGS. 3-5, shown therein is an example reader, a bioptic reader 300 with a video processing module (VPM) 302 provided in accordance with an embodiment of the present disclosure. Specifically, the reader 300 includes a housing 302 with a bottom portion 304 and a top portion 306 extending above the bottom portion 304. The bottom portion 304 including a bottom-portion window 308 and the top portion 306 including a top-portion window 310. The reader further includes a platter 312 positioned adjacent the top section of the bottom portion 304 of the housing 302 where the platter 312 has an optically transmissive window 314 that aligns with the bottom-portion window 308 of the bottom portion 304.

The reader 300 also include the VPM 316 for processing imaging data associated with a video stream, whereby the processing includes machine vision tasks other than indicia decoding. In the illustrated example, the VPM 316 is separate from the decoder module which can be implemented via a logical or a hardware module on the circuit board 318 positioned within the bottom portion 304 of the housing 302. As can be seen in the drawings, the VPM 316 is positioned within the top portion 306 of the housing 302, and in the illustrated example, it is sandwiched between an inner wall 320 of the upper portion 306 and a cover 322 adapted to be attached to the upper portion 306 via any appropriate fastening means like retaining clips, screws, fasteners, adhesive, etc. In some embodiments, the cover 322 is removably attached for access to the VPM.

In some embodiments the VPM is comprised of a printed circuit board 317 that can be advantageously oriented in an upright orientation whereby an upright orientation shall include an incline of up to 40 degrees off a vertical axis. In some embodiments the printed circuit board 317 is housed in a respective housing 319 which provides environmental protection to the components of the VPM. In other embodiment, the PCB 317 is provided without any additional housings. Additionally, the VPM may be secured either to the wall 320 or to an interior wall of the cover 322, depending on the desired design implementation.

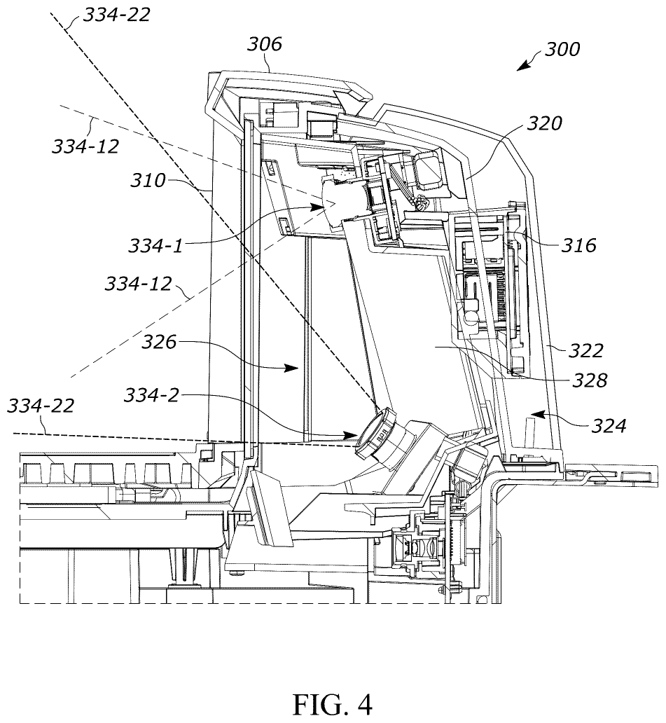

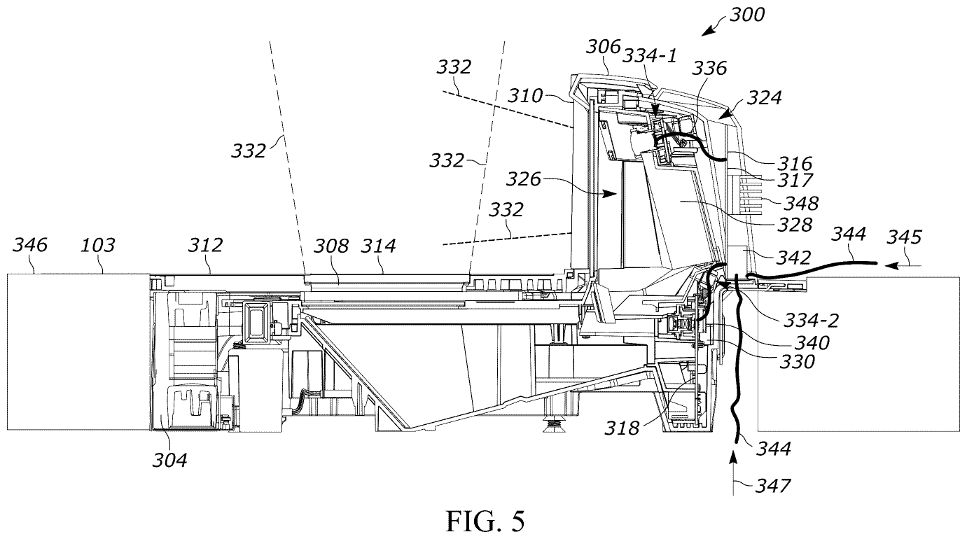

In the illustrated example, the cover 322 attaches to the rear of the upper portion 306 such that it creates a compartment 324 that can be accessed without disturbing the optical components on the rest of the reader 300. For example, referring to FIGS. 4 and 5, one can appreciate that the compartment 324 is separate from the compartment 326 which can be defined by the volume between the window 310 and the wall 320. It is in this compartment 326 that the reader 300 can include optical components like fold mirror(s) 328 for folding the field of view of the reader 300 such that it is directed into a product-scanning region of the reader above the platter 312. Preferably, the compartment 326 is environmentally sealed from compartment 324 such that if cover 322 is removed, compartment 326 remains environmentally sealed from being exposed to the environment. This can reduce the likelihood of dust, moisture, and/or other particulates from entering the interior of the reader 300 and interfering with the operation thereof.

The reader 300 includes two sets of imaging assemblies with a first set having at least one imaging assembly capturing image data that is transmitted to the decoder module, and the second set having at least one imaging assembly capturing image data that is transmitted to the VPM. In the illustrated example, the reader 300 includes a first imaging assembly 330 configured to capture first image data over a first FOV 332 extending through at least one of the bottom-portion window 308 and the top-portion window 310. The image data captured by this imaging assembly is transmitted to a decoder module like the decoder module 126 of FIG. 2, whereby the module decodes payloads of one or more indicia that may be present in the captured image data. The reader 300 also includes a set of second imaging assemblies 334-1 and 334-2 configured to capture second image data over a respective FOVs 334-12 and 334-22 extending through at least one of the bottom-portion window 308 and the top-portion window 310. The image data captured from these imaging assemblies is transmitted to the VPM 316 for processing.

To receive data from the imaging assemblies 344-1 and 344-2, the VPM 316 is communicatively coupled to each imaging assembly with a data bus. While different data paths are within the scope of the present disclosure, FIG. 5 illustrates that imaging assembly 334-1 is connected to the VPM 316 via a cable 336 and imaging assembly 334-2 is connected to the VPM 316 via a respective cable. Each of these cables may be integrally connected with either of the respective imaging assembly and the VPM, or it may include a releasable connector on any end thereof like, for example, a Universal Serial Bus connector, a mobile industry processor interface (MIPI) connector like the MIPI CSI-2 connector, or any other connector suitable for interfacing an imaging assembly with the VPM.

To enable the VPM 316 to communicate with various components, it can be provided with various IO ports suited for communication with devices other than imaging assemblies. For example, the VPM may be communicatively coupled to the circuit board 318 via cable 340, allowing for the exchange of information between the VPM 316 and the control circuitry for the reader 300. Such connectivity can allow for synchronization between the operation of the imaging assemblies 334-1 and 334-2, and the rest of the components of the reader 300 like illumination assemblies, remaining imaging assemblies, wake-up systems, and such.

Additionally, the VPM may include one of more ports 342 for receiving external cable(s) 344. This can allow the VPM to communicate with systems and devices outside the reader 300. In some embodiments, the port 342 is oriented to receive an external cable above the plane 346 defined by the top surface of the platter 312 and along a substantially horizontal direction 345. In other embodiments, the port 342 is oriented to receive an external cable from below the plane 346 and along an upright direction 347.

In some embodiments it may be desirable to provide the VPM with a heatsink 348 for dissipating the heat generated by the VPM 316 components like various integrated circuits. This heatsink 348 may be placed such that it protrudes beyond the boundary of the cover 322 or it may be fully encompassed within the compartment 324.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A bioptic indicia reader comprising:
a housing having a bottom portion and a top portion extending above the bottom portion, the bottom portion including a bottom-portion window and the top portion including a top-portion window;
a platter positioned adjacent the top section of the bottom portion of the housing, the platter having an optically transmissive window that aligns with the bottom-portion window of the bottom portion of the housing;
a decoder module positioned within the housing and configured to decode indicia provided to the decoder module in image data;
a video processing module that is separate from the decoder module, the video processing module configured to process a stream of image data representing a video stream, the video processing module being positioned at least partially within the top portion of the housing;
a first imaging assembly configured to capture first image data over a first field of view (FOV) extending through at least one of the bottom-portion window and the top-portion window, the first image data being transmitted to the decoder module; and
a second imaging assembly configured to capture second image data over a second FOV extending through at least one of the bottom-portion window and the top-portion window, the second image data being transmitted to the video processing module.

2. The bioptic indicia reader of claim 1, wherein the first imaging assembly include a first imaging sensor positioned within the bottom portion of the housing, and wherein the second imaging assembly includes a second imaging sensor positioned within the top portion of the housing.

3. The bioptic indicia reader of claim 1, wherein the top portion of the housing includes a first compartment and a second compartment separate from the first compartment,
wherein the first FOV is folded by a fold mirror positioned within the first compartment, and
wherein the video processing module is positioned within the second compartment.

4. The bioptic indicia reader of claim 3, wherein the second compartment includes a removable cover that, when remove, exposes the video processing module to an environment outside the housing of the bioptic indicia reader.

5. The bioptic indicia reader of claim 4, wherein the first compartment is sealed from the second compartment.

6. The bioptic indicia reader of claim 1, wherein the video processing module includes a printed circuit board oriented in an upright plane relative to a top surface of the platter.

7. The bioptic indicia reader of claim 6, wherein the printed circuit board includes a port for receiving an external cable, and wherein the port is oriented to receive the external cable from one of (i) below a plane defined by a top surface of the platter and along an upright direction or (ii) above the plane defined by the top surface of the platter and along a substantially horizontal direction.

8. The bioptic indicia reader of claim 1, wherein the video processing module includes a heatsink configured to transmit heat generated by at least one component of the video processing module to a surface that is exposed to an environment outside the housing of the bioptic indicia reader.

9. The bioptic indicia reader of claim 1, wherein the second imaging assembly includes a first transmission port, wherein the video processing module includes a second transmission port, and wherein the second imaging assembly and the video processing module are connected via a cable connecting the first transmission port and the second transmission port.

10. The bioptic indicia reader of claim 9, wherein at least one of the first transmission port and the second transmission port is a universal serial bus port or a MIPI port.

11-20. (canceled)
